(19) United States
(12) Patent Application Publication
(10) Pub. No.: US 2006/0184265 A1
(43) Pub. Date: Aug. 17, 2006

(54) Wafer lot split method and system

(75) Inventors: Hui-Mei Tseng, Hsinchu City (TW); Chi-Kung Hung, Chiayi City (TW); Yuan-Chi Yang, Hsinchu City (TW); Jung-Ying Wu, Hsinchu City (TW)

Correspondence Address: BIRCH STEWART KOLASCH & BIRCH, PO BOX 747, FALLS CHURCH, VA, 22040-0747, US

(73) Assignee: Powerchip Semiconductor Corp.

(21) Appl. No.: 11/347,235

(22) Filed: Feb. 6, 2006

(30) Foreign Application Priority Data
Feb. 14, 2005 (TW) 94104172

(51) Int. Cl. G06F 19/00

(52) U.S. Cl. 700/121; 700/116

(57) ABSTRACT

A computer-implemented wafer lot split method is disclosed. A database is provided. The database is coupled to manufacturing tools in a wafer manufacturing environment. Split parameters for a wafer lot are predetermined in the database. The wafer lot is split according to the split parameters to acquire child wafer lots.

### BACKGROUND

The invention relates to wafer manufacturing methods, and in particular to computer-implemented wafer lot split methods and systems.

With the technical progress of integrated circuit (IC) products and computer integrated manufacturing system (CIM), wafer lot split, splitting a wafer lot in one carrier to different wafer lots processed in different operations thereafter, has become an important technique for wafer manufacturing.

A wafer lot split divides a full wafer lot into several different wafer lots according to requirements. The wafer lot to be split is a parent lot and the split wafer lots are child wafer lots. Wafer lot split requires split data, for example, a split station to execute wafer lot split operation. The split data needs to be predetermined, such that when a wafer lot arrives at a split station, the wafer lot can be split correctly. Currently, the manufacturing of IC products is generally integrated with manufacturing execution systems (MES) for management and control. However, the MES integrated with the manufacture of IC products lacks predetermination functions for wafer lot splits. Thus, split results and situations cannot be predicted before a wafer lot is actually split.

Due to predetermination of wafer lot splitting's importance for IC product manufacturing, most predetermination of wafer lot splits is performed manually. For example, operators process documents according to requirements of wafer lot splits. The processed documents are then transferred to on-line manufacturing departments. The on-line manufacturing departments execute wafer lot splits accordingly when wafer lots arrive to certain split stations. The on-line manufacturing departments also record split related data, such as child lot identifications (lot IDs), for further processing.

The manual operations are time-consuming and resource-wasting. The manual operations cannot be integrated into automatic manufacturing systems, reducing performance. Thus, predetermined wafer lot split methods and systems for manufacturing tools in a wafer manufacturing environment are desirable.

### SUMMARY

One object of the present invention is to provide wafer lot split methods. The provided methods split wafer lots previously in manufacturing processes to advance automation of wafer manufacturing factories.

Computer-implemented wafer lot split methods are provided. A database, such as a MES database, is provided. The database is coupled to manufacturing tools in a wafer manufacturing environment. Split parameters for a wafer lot are predetermined in the database. The wafer lot is split according to the split parameters to acquire child wafer lots. Key numbers for each child wafer lot are acquired. Each child wafer lot can be processed in different manufacturing process according to the key numbers. Thus, if the key numbers can be acquired in advance, child wafer lot can be processed and set separately. A verification procedure can be executed to verify results for the wafer lot split. Here, because the wafer lot split is predetermined by systems to replace manual operations, the verification procedure can be executed before the wafer lot split is actually executed.

The split child wafer lots are then processed according to the key numbers by the manufacturing tools. Furthermore, the manufacturing tools can process the child wafer lots in different processes based on the key numbers.

Embodiments of the invention provide wafer lot split methods for manufacturing tools in a wafer manufacturing environment, reducing manual operations and increasing performance. Additionally, the key numbers of child wafer lots can be acquired in advance. Thus, the child wafer lots can be processed in different processes according to the key numbers, increasing performance of data management.

Moreover, wafer lot split systems for manufacturing tools in a wafer manufacturing environment are provided. The provided systems comprise a setting module. The setting module is coupled to a database. The database can be a MES database coupled to the manufacturing tools. The manufacturing tools process wafer lots.

The setting module predetermines split parameters for a wafer lot in the database and splits the wafer lot according to the split parameters to acquire child wafer lots. The setting module also acquires a key number for each child wafer lot. A verification module is provided to execute a verification procedure for verifying results of the wafer lot split. Thereafter, the child wafer lots are processed by the manufacturing tools according to their corresponding key numbers.

Additionally, wafer manufacturing processes are provided. The provided processes first predetermine split data for each wafer lot of at least one wafer lot in a manufacturing execution system. The split data comprises child wafer lot identifications corresponding to split child wafer lots, a split station, and a wafer split number. Control functions for each split child wafer lot are then set. Finally, wafer lot split is executed by using the manufacturing execution system according to the split data when the wafer lot arrives to the split station.

### BRIEF DESCRIPTION OF THE DRAWINGS

Embodiments of the invention can be more fully understood by reading the subsequent detailed description and examples with references made to the accompanying drawings, wherein:

FIG. 1 is a flowchart of an embodiment of a computer-implemented wafer lot split method.

FIG. 2 is a diagram of an embodiment of wafer lot split system.

### DETAILED DESCRIPTION

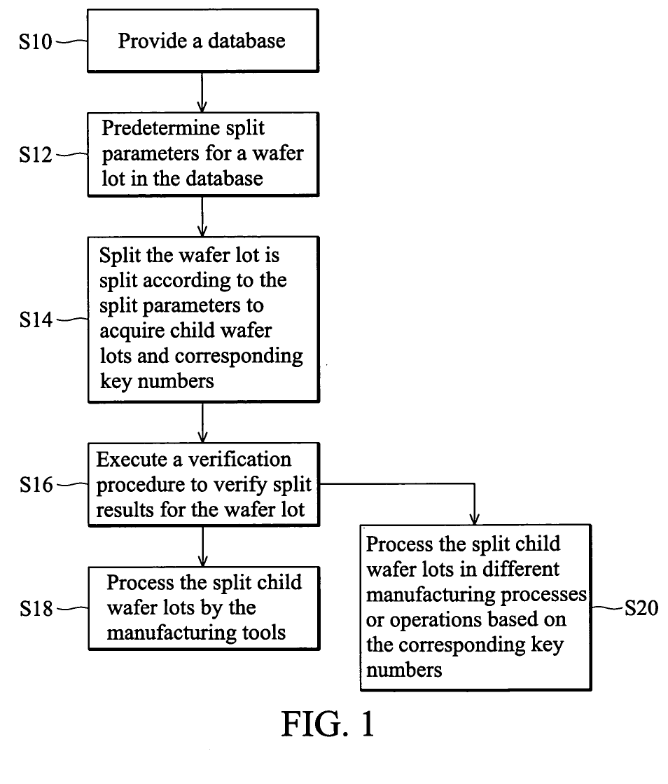

FIG. 1 is a flowchart of an embodiment of a computer-implemented wafer lot split method for a wafer manufacturing environment with manufacturing tools. A database, coupled to the manufacturing tools, is provided (step S10). For example, the provided database can be a MES database. Split parameters for a wafer lot are predetermined in the database (step S12). The wafer lot is split according to the split parameters to acquire child wafer lots and corresponding key numbers (step S14). A verification procedure can be executed to verify split results for the wafer lot during the wafer lot split (step S16). Because the predetermination is executed by a system, replacing manual operations, the wafer lot split can first be simulated and checked. The wafer lot split can be executed only when the check result is correct. Thereafter, the split child wafer lots can be processed by the manufacturing tools according to the key numbers (step S18). For example, the split wafer lots can be processed in different manufacturing processes or operations based on the corresponding key numbers (step S20).

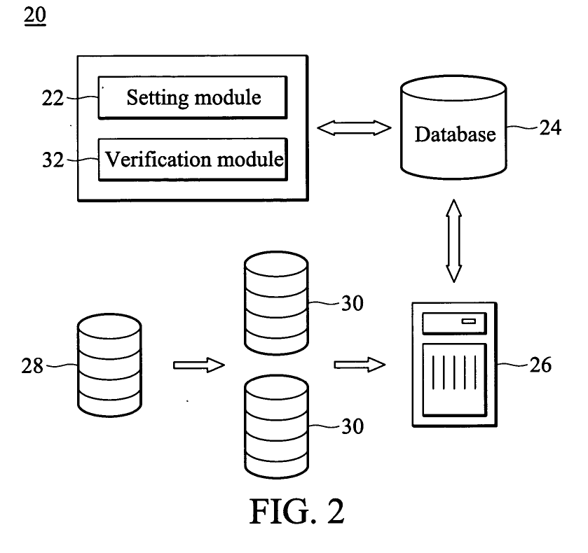

FIG. 2 is a diagram of an embodiment of a wafer lot split system 20 for manufacturing tools 26 in a wafer manufacturing environment, comprising a setting module 22. The setting module 22 is coupled to a database 24. The database 24 can be a MES database coupled to the manufacturing tools 26. The manufacturing tools 26 process wafer lots 28.

The setting module 22 predetermines split parameters for a wafer lot 28 in the database 24 and splits the wafer lot 28 according to the split parameters to acquire child wafer lots 30. The setting module 22 also acquires a key number for each child wafer lot 30. A verification module 32 is provided to execute a verification procedure for verifying results of the wafer lot split. Thereafter, the child wafer lots 30 are processed by the manufacturing tools 26 according to their corresponding key numbers. For example, the manufacturing tools 26 may process the child wafer lots 30 in different operations, such as etching, cleaning, or CMP (Chemical Mechanical Polishing), based on their corresponding key numbers.

Returning to FIG. 2, in one embodiment, the provided method is applied to a wafer manufacturing system. For example, managers or management programs can execute wafer lot split by the setting module 22. The split results are recorded to a MES database 24. When a wafer lot arrives at a manufacturing tool, the wafer is verified. The verification focuses on the predetermination of the wafer lot. If the predetermination of wafer lot split of the arrived wafer lot is finished and the verification result reveals correctly, the wafer lot is split. The wafer lot split can be accomplished in a wafer stocker or a wafer sorter.

As shown in FIG. 2, in one embodiment, the predetermination of a wafer lot split is accomplished and recorded in a MES database 24. When a wafer lot 28 arrives at a manufacturing tool 26, a verification procedure is executed. If the verification result is correct, the arriving wafer lot 28 is split into different child wafer lots. The split child wafer lots can be transferred to different carriers. For example, the wafer lot 28 arrives at the manufacturing tool 26 and is split into two different child wafer lots 30. The child wafer lots 30 are transferred to two different carriers, one original and one new carriers or two new carriers, depending on actual requirements. Thereafter, child wafer lots in different carriers can be processed in different manufacturing recipes.

Furthermore, referring to FIG. 2 again, in one embodiment, the provided methods can be applied to a wafer manufacturing process. Split data for each wafer lot 28 is predetermined in a manufacturing execution system (MES). The split data is recorded to a database 24. The split data for each wafer lot includes child wafer lot identifications corresponding to split child wafer lots, a split station, and a wafer split number. Control functions for each split child wafer lot are then set. The split child wafer lots are processed thereafter according to the control functions, such as “further hold”, “set merge point”, “set lot note”, and “set on-line recipe”. A wafer lot is split by using the manufacturing execution system according to the split data when it arrives at the split station. The manufacturing execution system can also control and manage the manufacturing process. For example, if the manufacturing process is not executed according to the split data, the manufacturing execution system may execute a check and stop the wafer lot split to maintain the correction of the manufacturing process.

Embodiments of the invention provide wafer lot split methods for manufacturing tools in a wafer manufacturing environment, reducing manual operations and increasing performance.

It will be appreciated from the foregoing description that the method and system described herein provide solid solutions for wafer lot split problems. If, for example, the manufacturing processes os the child wafer lots are altered, the methods and systems of the present invention can be adjusted accordingly.

Methods of the invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A computer-implemented wafer lot split method, comprising:
providing a database, coupled to a plurality of manufacturing tools in a wafer manufacturing environment;
predetermining split parameters for a wafer lot in the database; and
splitting the wafer lot according to the split parameters to acquire at least one child wafer lot.

2. The computer-implemented wafer lot split method as claimed in claim 1, further comprising processing the child wafer lots by using the manufacturing tools.

3. The computer-implemented wafer lot split method as claimed in claim 1, wherein the database is a manufacturing execution system database.

4. The computer-implemented wafer lot split method as claimed in claim 1, wherein the wafer lot split further acquires a key number for each child wafer lot.

5. The computer-implemented wafer lot split method as claimed in claim 4, wherein the step of splitting the wafer lot split further comprises processing child wafer lots according to the key numbers.

6. The computer-implemented wafer lot split method as claimed in claim 1, further comprising executing a verification procedure to verify results of the wafer lot split.

7. A wafer lot split system for a plurality of manufacturing tools in a wafer manufacture environment, comprising a setting module, coupled to a database, for predetermining split parameters for a wafer lot in the database and splitting the wafer lot according to the split parameters to acquire at least one child wafer lot, wherein the database is coupled to the manufacturing tools.

8. The wafer lot split system as claimed in claim 7, wherein the manufacturing tools process the child wafer lots in the manufacturing tools after the wafer lot split.

9. The wafer lot split system as claimed in claim 7, wherein the database is a manufacturing execution system database.

10. The wafer lot split system as claimed in claim 7, wherein the setting module is used for acquiring a key number for each child wafer lot.

11. The wafer lot split system as claimed in claim 10, wherein the manufacturing tools are used for processing the child wafer lots according to the key numbers.

12. The wafer lot split system as claimed in claim 7, further comprising a verification module to execute a verification procedure to verify results of the wafer lot split.

13. A wafer manufacturing process, comprising:
predetermining split data for each wafer lot of at least one wafer lot in a manufacturing execution system, wherein the split data comprises at least one child wafer lot identification corresponding to split child wafer lot, a split station, and a wafer split number;
setting a control function for each split child wafer lot; and
executing wafer lot split using the manufacturing execution system according to the split data when the wafer lot arrives to the split station.

14. The wafer manufacturing process as claimed in claim 13, wherein if the manufacturing process is not executed according to the split data, the manufacturing execution system executes a check and stops the wafer lot split.

15. The wafer manufacturing process as claimed in claim 13, wherein the control functions comprise “further hold”.

16. The wafer manufacturing process as claimed in claim 13, wherein the control functions comprise “set merge point”.

17. The wafer manufacturing process as claimed in claim 13, wherein the control functions comprise “set lot note”.

18. The wafer manufacturing process as claimed in claim 13, wherein the control functions comprise “set on-line recipe”.
